(19) United States
(12) Patent Application Publication
(10) Pub. No.: US 2025/0128555 A1
(43) Pub. Date: Apr. 24, 2025

(54) VEHICLE COMMUNICATION SYSTEM

(71) Applicant: R.A. PHILLIPS INDUSTRIES, INC., Irvine, CA (US)

(72) Inventors: James Epler, Santa Fe Springs, CA (US); Robert Alexander Phillips, Laguna Niguel, CA (US); Daniel William Forthoffer, Birmingham, MI (US); Clifford Creech, Santa Fe Springs, CA (US); Gil Israel Winograd, Santa Fe Springs, CA (US)

(21) Appl. No.: 18/920,590

(22) Filed: Oct. 18, 2024

Related U.S. Application Data
(60) Provisional application No. 63/591,744, filed on Oct. 19, 2023.

(51) Int. Cl. B60D 1/62; B60R 16/023; H04L 12/40

(52) U.S. Cl. CPC B60D 1/62; B60R 16/0234; H04L 12/40; H04L 2012/40215; H04L 2012/40273

(57) ABSTRACT

A gateway device of a trailer includes a processing circuit configured to enable bi-directional communication between electrical devices at the trailer and an electrical system of the tractor; and a housing encompassing the processing circuit and coupled to an underside of the trailer, the housing including a terminal configured to be electrically coupled to an electrical socket at a front side of the trailer via a single cable that passes through a kingpin plate at the underside of the trailer.

### CROSS-REFERENCE TO RELATED APPLICATION(S)

This application claims priority to, and the benefit of, U.S. Provisional Application No. 63/591,744 (“SMART VEHICLE CONNECTION BOX”), filed on Oct. 19, 2023, the entire content of which is incorporated herein by reference.

### FIELD

Aspects of the invention relate to the field of trailer connectivity solutions within the transportation industry.

### BACKGROUND

As trailers become more integrated with technology and smart systems, the demand for advanced connectivity solutions has surged. These solutions ensure efficient communication between the trailer, the cargo, the towing vehicle, and even external systems like fleet management software or real-time tracking platforms.

With modern semi-truck trailers, two components generally constitute the control system of the trailer. One component incorporates electrical interfaces and circuit boards and performs the majority of the braking system control. The other component traditionally handles the activation of lighting systems, power, and communications transmission to and from the towing vehicle, and more recently, manages telematics. North American systems continue to become more sophisticated to accommodate features and functions that do not necessarily pertain to braking systems, while European trailers have taken a more modularized approach where new functionality is generally added with the addition of a new independent module.

The above information disclosed in this Background section is only for enhancement of understanding of the invention, and therefore it may contain information that does not form the prior art that is already known to a person of ordinary skill in the art.

### SUMMARY

Aspects of some embodiments of the invention are directed toward a gateway device for trailers, enabling bi-directional communication between trailer devices and a tractor's electrical system. The device features a processing circuit housed under the trailer, connected to an electrical socket at the front of the trailer via a single cable passing through the kingpin plate. It supports various communication protocols, including Ethernet, power line carrier (PLC), and controller area network (CAN), and can interface directly with vehicle systems without ABS module intervention. The compact design allows easy retrofitting and compatibility with different trailer types, enhancing connectivity and operational efficiency.

Aspects of some embodiments of the invention are directed toward a vehicle communication system using said gateway device.

According to some embodiments of the present disclosure, there is provided a gateway device of a trailer, including: a processing circuit configured to enable bi-directional communication between electrical devices at the trailer and an electrical system of the tractor; and a housing encompassing the processing circuit and coupled to an underside of the trailer, the housing including a terminal configured to be electrically coupled to an electrical socket at a front side of the trailer via a single cable that passes through a kingpin plate at the underside of the trailer.

In some embodiments, the housing is coupled between two adjacent cross-beams above a landing gear of the trailer.

In some embodiments, the processing circuit is configured to directly communicate with at least one of a vehicle communication system (VCS) or a human-machine interface (HMI) at the tractor, without intervention of an anti-lock braking system (ABS) module of the tractor.

In some embodiments, the processing circuit is configured to communicate with an anti-lock braking system (ABS) module of the tractor via at least one of power line carrier (PLC) communication links or a controller area network (CAN)-based connection.

In some embodiments, the processing circuit includes an ethernet router configured to establish an ethernet-based connection between one or more cameras at the trailer and the electrical system of the tractor.

In some embodiments, the processing circuit is configured to enable communication between a first anti-lock braking system (ABS) module at the tractor and a second anti-lock braking system (ABS) module at the trailer via power line carrier (PLC) communication links.

In some embodiments, the processing circuit is configured to establish a controller area network (CAN)-based connection between one or more devices at the trailer and the electrical system of the tractor.

In some embodiments, the one or more devices at the trailer include at least one of a tire pressure sensor or a light check sensor.

In some embodiments, the single cable passes through an opening in the kingpin plate at the underside of the trailer, the opening having a diameter of about 1 inch to about 2 inches.

According to some embodiments of the present disclosure, there is provided a communication system of a trailer, including: a gateway device configured to enable bi-directional communication between electrical devices at the trailer and an electrical system of the tractor, and coupled to an underside of the trailer; and an electrical socket at a front side of the trailer and configured to be coupled to an electrical system of a tractor via a harness, the electrical socket being communicatively coupled to the gateway device via a single cable that passes through a kingpin plate at the underside of the trailer.

In some embodiments, the gateway device is coupled between two adjacent cross-beams above a landing gear of the trailer.

In some embodiments, the gateway device is configured to directly communicate with at least one of a vehicle communication system (VCS) or a human-machine interface (HMI) at the tractor, without intervention of an anti-lock braking system (ABS) module of the tractor.

In some embodiments, the gateway device is configured to communicate with an anti-lock braking system (ABS) module of the tractor via at least one of a power line carrier (PLC) communication links, an ethernet link, or a controller area network (CAN)-based connection.

In some embodiments, the gateway device includes an ethernet router configured to establish an ethernet-based connection between one or more cameras at the trailer and the electrical system of the tractor.

In some embodiments, the gateway device is configured to enable communication between a first anti-lock braking system (ABS) module at the tractor and a second anti-lock braking system (ABS) module at the trailer via power line carrier (PLC), ethernet, and/or controller area network (CAN) communication links.

In some embodiments, gateway device is configured to establish a controller area network (CAN)-based connection between one or more devices at the trailer and the electrical system of the tractor.

In some embodiments, the one or more devices at the trailer include at least one of a tire pressure sensor or a light check sensor.

In some embodiments, the electrical socket includes a SAE J560 socket, and wherein the harness is a primary and auxiliary seven conductor electrical connector for truck-trailer jumper cable.

In some embodiments, the electrical socket includes an EC47 socket including an ethernet terminal, a controller area network (CAN) terminal, and a J560 receptor, and

wherein the harness includes conductors for carrying ethernet signals, CAN signals, and signals compatible with SAE J560.

In some embodiments, the single cable passes through an opening in the kingpin plate at the underside of the trailer, the opening having a diameter of about 1 inch to about 2 inches.

Other aspects, features, and characteristics that are not described above will be more clearly understood from the accompanying drawings, claims, and detailed description.

### BRIEF DESCRIPTION OF THE DRAWINGS

Non-limiting and non-exhaustive embodiments according to the present disclosure are described with reference to the following figures, wherein like reference numerals refer to like parts throughout the various views unless otherwise specified.

FIG. 1 illustrates a vehicle utilizing a communication system, according to some embodiments of the present disclosure.

FIGS. 2A and 2B illustrate a side view and a top view, respectively, of a gateway device that is attached to cross-members at the underside of the trailer, according to some embodiments of the present disclosure.

FIG. 3 illustrates a block diagram of a processing circuit of the gateway device, according to some embodiments of the present disclosure.

FIG. 4A illustrates an electrical socket according to some embodiments of the present disclosure.

FIG. 4B illustrates an electrical socket according to some other embodiments of the present disclosure.

### DETAILED DESCRIPTION

The detailed description set forth below is intended as a description of example embodiments of the invention, and is not intended to represent the only forms in which the invention may be constructed or utilized. The description sets forth the features of the invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

In the present disclosure, processes, elements, and techniques that are not considered necessary for those having ordinary skill in the art to have a complete understanding of the aspects and features of the present disclosure may not be described or may be only briefly described. In the drawings, the relative sizes of elements, layers, and regions may be exaggerated for clarity.

In the field of trailer connectivity solutions within the transportation industry, the integration of technology and smart systems in trailers has led to a growing demand for advanced connectivity solutions. These solutions ensure efficient communication between the trailer, the cargo, the towing vehicle, and external systems such as fleet management software or real-time tracking platforms. As trailers become more technologically advanced, the need for robust and efficient communication systems becomes increasingly significant.

Historically, trailers, particularly in North America, have relied on “nose boxes” for connectivity needs. These boxes serve as the central hub for electrical connections, ensuring power distribution and basic signal transmission. Traditional nose boxes present several challenges.

In general, features upgrades of new nose boxes require additional wiring to facilitate. For example, the inclusion of a CAN network into the nose box requires additional wiring to be run through the kingpin plate of the trailer. This can be challenging considering this structural member of the trailer (i.e., the king plate) can only accommodate so many pull-through holes before its durability and longevity is compromised.

Also, retrofitting new nose boxes to older trailers or those with designs can be difficult, often requiring significant modifications. For example, many in the trailer industry may not upgrade nose boxes due to the different bolt patterns and wiring connections required to facilitate the upgrade.

Additionally, the location of these boxes exposes them to potential damage that would otherwise be mitigated by the protective front of the trailer itself (usually incorporating steel plates to protect the nose of the trailer and its contents).

According to some embodiments, the present disclosure provides a gateway device designed to address these challenges. This system offers a more advanced, durable, integrated, and cost-effective connectivity solution for trailers. The smart vehicle connection box enables bi-directional communication between trailer devices and a tractor's electrical system, supporting various communication protocols such as Ethernet, power line carrier (PLC), and controller area network (CAN). The compact design allows for easy retrofitting and compatibility with different trailer types, enhancing connectivity and operational efficiency.

According to some embodiments, a communication system utilizing the gateway enhances trailer connectivity by enabling bi-directional communication between trailer devices and the tractor's electrical system. By utilizing a single cable through the kingpin plate of the trailer, the system reduces (e.g., minimizes) structural modifications, preserving the trailer's integrity while providing advanced connectivity solutions.

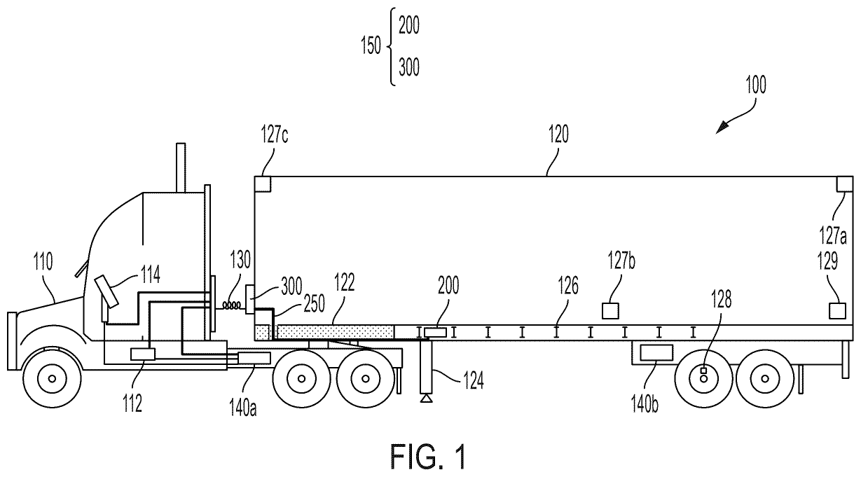

FIG. 1 illustrates a vehicle 100 utilizing a communication system 150, according to some embodiments of the present disclosure.

Referring to FIG. 1 the vehicle (e.g., the heavy duty vehicle) 100 includes a tow vehicle (also referred to as a truck or tractor) 110 and a trailer 120. The tow vehicle 110 provides the necessary power and control for the trailer 120 when attached to the tow vehicle 110. Hereinafter, the term “trailer” may refer to a walled/covered semi-trailer, a flatbed trailer, or a chassis.

The trailer 120 includes a kingpin plate 122 at its front underside, which facilitates the connection between the tow vehicle 110 and the trailer 120, allowing for secure attachment and efficient towing. The kingpin plate 122 is a structural component, designed to withstand the forces exerted during towing. Positioned at the front underside of the trailer 120, the kingpin plate 122 provides a stable base for the connection between the tractor 110 and the trailer 120.

The trailer 120 also includes landing gear 124 and a plurality of cross-members (e.g., cross-beams) 126 at the underside of the trailer 120. The landing gear 124 is located beneath the trailer 120 and provides support when the trailer 120 is not attached to the tow vehicle 110. The landing gear 124 ensure that the trailer 120 remains level and secure when stationary and maintains the trailer's stability during loading and unloading operations. The cross-member 126 is a part of the trailer's structural framework. Positioned transversely across the bottom of the trailer 120, the cross-member 126 provides additional support and rigidity.

According to some embodiments, the vehicle (e.g., the trailer 120) is equipped with a communication system 150, which is attached to the trailer 120. The communication system 150, includes a gateway device 200 and an electrical socket 300.

The gateway device 200 is configured to enable bi-directional communication between electrical devices at the trailer and an electrical system of the tractor. In some embodiments, the gateway device 200 is coupled to the underside of the trailer 120, strategically positioned to facilitate communication while reducing (e.g., minimizing) structural modifications. For example, the gateway device 200 may be coupled between two adjacent cross-members 126 above the landing gear 124 of the trailer 120.

The electrical socket 300 is located at the front side of the trailer 120. The electrical socket 300 is configured to be electrically coupled to an electrical system of the tractor 110 via a harness 130. That is, the electrical socket 300 facilitates the transfer of electrical signals between the tractor 110 and the trailer 120, enabling bi-directional communication. In some embodiments, the electrical socket 300 is communicatively coupled to the gateway device 200 via a single cable (or interlink) that passes through the kingpin plate 122 at the underside of the trailer 120.

In some examples, the trailer 120 may be equipped with various sensors and devices, including one or more cameras 127 (e.g., a rear-view camera and side-view cameras), one or more light check sensors 129, and one or more tire pressure sensors 129, and/or the trailer anti-lock braking system (ABS) module 140b. However, embodiments of the present disclosure are not limited thereto. For example, the trailer 120 may be equipped with a variety of sensors including a cargo sensor, a thermal camera, a wheel-end temperature sensor, an axle lube temperature sensor, an ultrasonic or radar back up sensor, a backup time-of-flight sensor, a kingpin height sensor, boogey position sensor, door sensor, door lock sensor, an ATIS pressure sensor, an ATIS status sensor, a yaw sensor, an accelerometer, a lane keeping sensor, a liftgate battery voltage/current sensor, a liftgate cycle counter, a brake pad wear sensor, a brake temperature sensor, a tire treadwear sensor, a blind spot monitoring sensor, a wheel speed sensor, a weight sensor, a floor load sensor, and/or the like.

In some embodiments, the gateway device 200 is electrically coupled to (e.g., directly coupled to) these components allowing for real-time data exchange and enhanced control operations. To facilitate such communication, the gateway device 200 may support various communication protocols, including Ethernet, power line carrier (PLC), and/or controller area network (CAN), thus enhancing connectivity and operational efficiency. For example, the gateway device 200 may communicate with the one or more cameras 127, which may utilize high data bandwidth, via one or more Ethernet connections. The gateway device 200 may communicate with the various trailer sensors (e.g., 129) via a controller area network (CAN)-based connection. Further, the gateway device 200 may communicate with the trailer ABS module 140b via at least one of a power line carrier (PLC) communication link or a CAN-based connection.

The electrical socket 300 and harness 130 combination allow the gateway device 200 (and the trailer devices connected to it) to communicate with various electronic devices at the tractor 110 including a vehicle communication system (VCS) 112, a human-machine interface (HMI) 114, and/or the tractor ABS module 140a (i.e., the truck brake controller). The VCS 112 may be part of a computer network in which vehicles and roadside units are the communicating nodes, providing each other with information, such as safety warnings and traffic information. The HMI 114 may act as the primary point of interaction between the driver and the vehicle's various systems, allowing them to control functions, monitor vehicle status, receive alerts, and access information through a user-friendly display, typically including a touchscreen, buttons, and dials, which helps the driver operate the truck more efficiently and safely by presenting relevant information in a clear and intuitive way.

In the related art, the electronics at the trailer 120 may broadcast only limited data from a PLC bus to tow vehicle 110. This data is only shared with the tractor ABS module 140a, which is responsible for re-broadcasting the information to the electrical system of the tow vehicle 110 (e.g., the VCS 112) via a J1939 CAN. Trailer sensor and actuator data, which is often transmitted over a CAN bus, may only be available to the trailer ABS module 140b or the nose box of the trailer 120. Thus, in the related art, truck OEMs (original part manufacturers) often do not have direct control over the implementation of additional features and are forced to rely on ABS OEMs to implement the features as part of their ABS module. However, because the ABS is considered a mission critical component, any modification would have to undergo a significant and lengthy testing process, which makes the implementation of additional features a prolonged and arduous task.

To resolve this problem, in some embodiments, the gateway device 200 is capable of entirely bypassing the tractor ABS module 140a and directly communicating with the tractor VCS 112 and/or HMI 114 (i.e., without intervention of, or routing signals through, the tractor ABS module 140a). As a result, significantly more data may become available to the tractor 110 via CAN (e.g., ISO11992 and/or J1939 CAN), PLC, and/or ethernet. This may enable a whole new level of safety, efficiency, and driver situational awareness. Further, because data transmission to the tractor 110 can bypass the tractor ABS module 140a, truck OEMs can be in control of what trailer data they have access to and the trailer OEM has full control over their selection of sensors and the control system in the trailer. The ABS module and ABS system suppliers provide ABS systems and controls, but are no longer responsible for the entire trailer system. This allows OEMs to bypass traditional limitations and provide advanced connectivity solutions.

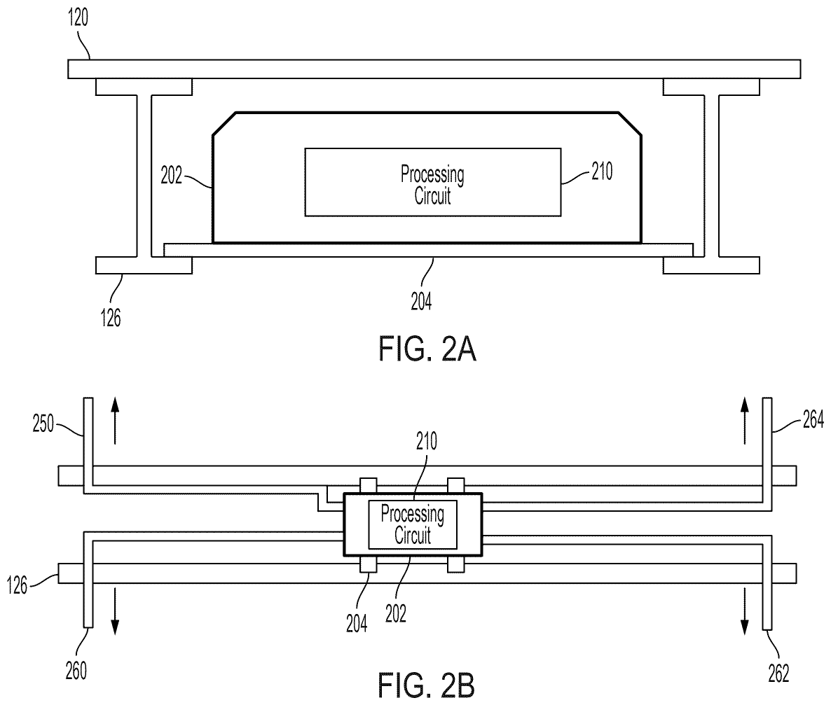

FIGS. 2A and 2B illustrate a side view and a top view, respectively, of a gateway device 200 that is attached to cross-members 126 at the underside of the trailer 120, according to some embodiments of the present disclosure.

Referring to FIGS. 2A-2B, in some embodiments, the gateway device 200 includes a housing 202 and a mounting bracket 204, which facilitates secure attachment to the trailer structure.

In some embodiments, the gateway device 200 is designed to be coupled between two adjacent cross-members 126 at the bottom of the trailer. For example, the mounting bracket 204 may include two bars (e.g., two parallel bars) attached to the housing 202 (e.g., to the bottom of the housing 202), which have ends that are fixedly coupled to the opposing flanges of the adjacent cross-members 126. In some examples, the ends of the bracket bars may be secured to the flanges of the cross-members 126 via welding, fastening (e.g., by screws), or any other suitable attachment mechanism. Thus, the mounting bracket 204 ensures that the gateway device 200 remains stable and securely positioned, even under the dynamic conditions experienced during trailer operation.

According to some embodiments, the gateway device 200 is positioned between the two cross-members 126 above the landing gears 124 of the trailer 120. Various trailers may have different spacing between adjacent cross-members 126 (e.g., 4 inches, 8 inches, 12 inches, etc.); however, at least in North American trailers, the spacing between cross-members above the landing gear is generally standardized to about 12 inches. Thus, attaching the gateway device 200 above the landing gear 124 ensures that there is sufficient space between the cross-members 126 to accommodate the housing 202 of the gateway device 200. This provides cross-compatibility between trailer OEMS and retrofit. Further, the presence of the landing gear 124 below the gateway device 200 affords an added layer of physical protection against environmental factors, such as flying debris, during the operation of the vehicle 100, and helps to dissuade unwanted tampering with the device 200 by unauthorized users. As will be understood by those of skill in the art, the position of gateway device 200 is not limited to that described above, and the gateway device may be positioned at any other suitable location (e.g., between cross-beams further behind the landing gear 124 or further ahead of it).

The housing 202, which forms the outer shell of the gateway device 200 may be made from a blend of high-grade polymers, ensuring resilience against environmental adversities while maintaining a lightweight profile. The housing 202 encompasses the processing circuit 210 that enables advanced connectivity and communication functionalities including bi-directional communication between electrical devices at the trailer 120 and the electrical system of the tractor 110.

As illustrated in FIG. 2B, the gateway device 200 may be connected to the various components of the trailer via a plurality of harnesses/cables, each with a number of conductors carrying different signals. For example, a first harness 250 may electrically couple to the electrical socket 300 at a front side of the trailer 120 by passing through single hole (e.g., an opening having a diameter of about 1 inch to about 2 inches) in the kingpin plate 122 at the underside of the trailer 120. A second harness 260 and/or a third harness 262 may be routed rearward and connect to midturn lights, rear lights, cameras, etc. A fourth harness 264 may be routed to the front of the trailer for connecting to clearance light, ATIS lights, etc.

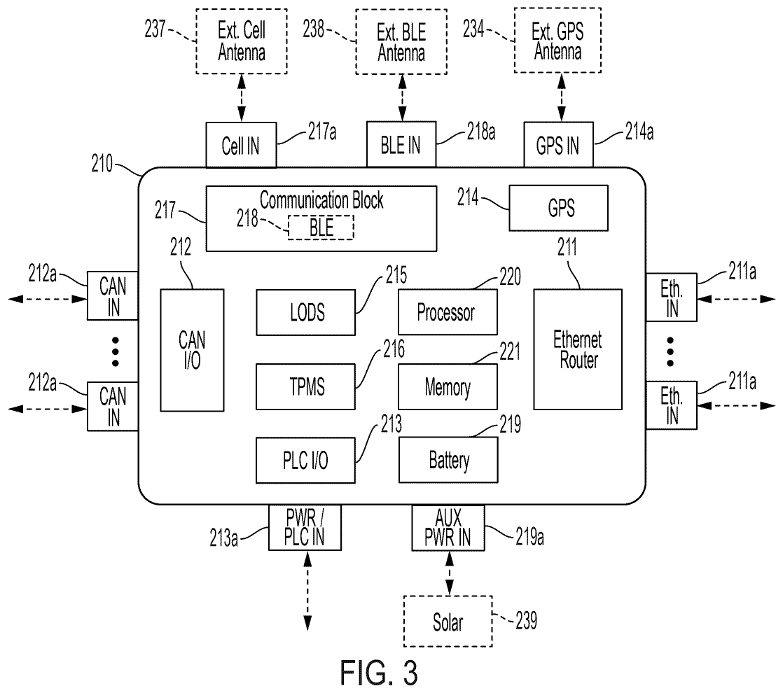

FIG. 3 illustrates a block diagram of a processing circuit 210 of the gateway device 200, according to some embodiments of the present disclosure.

In some embodiments, the processing circuit 210 includes an ethernet router 211, a CAN input/output (I/O) interface 212, a PLC I/O interface 213, a global positioning (GPS) device 214, a light-out detection system (LODS) 215, a tire pressure monitoring system (TPMS) 216, a communication block 217, a battery 219, a processor 220, and a memory 221. However, embodiments of the present disclosure are not limited thereto, and one or more of said components may be omitted from the processing circuit 210 or additional components providing a variety of functions may be added as desired.

The ethernet router 211 is configured to establish an ethernet-based connection between one or more devices at the trailer 120 and the electrical system of the tractor 110. The high-speed data transfer capability provided by the ethernet connection(s) allows the gateway device 200 to support advanced telematics integration and IoT functionalities. In some examples, the gateway device 200 may have one or more ethernet input ports (e.g., ethernet input terminals) 211a that allow the gateway device 200 to independently communicate with one or more ethernet devices 127, such as with a rear-view camera 127a, two side-view cameras 127b, and/or a nose-mounted camera 127c (see, e.g., FIG. 1). The gateway device 200 is capable of concatenating the various ethernet networks and signals, and crossing the communications between them intelligently via its incorporated network switches and routers. For example, due to the limited number of ethernet connections at the electrical socket 300, in the case of multiple ethernet inputs to the gateway device 200, the ethernet router 211 may intelligently combine (e.g., multiplex) the incoming feeds (e.g., camera feeds) into a fewer number of streams (e.g., a single stream) for transmission to the tractor 110. In some examples, gateway device 200 may join the view streams from the rear-view camera 127a, the two side-view cameras 127b, and the nose mounted camera 127c into a single surround view of the trailer 120 that can then be transposed onto the ethernet network shared by the tractor 110 so that it is visible to the driver. In some examples, the VSC 112 and the HMI 114 of the tractor 110 may be able to directly receive one or more ethernet connections from the gateway device 200 (via the cable 250 and the electrical socket 300) for processing and/or display to a human driver. This direct connection enables the gateway device 200 to completely bypass the tractor ABS module 140a when communicating with the VSC 112 and the HMI 114.

Due to the limitation that only a single hole be formed in the kingpin plate 122, in examples in which a nose-view camera 127c is used, this ethernet input will pass through the nose plate of the trailer 120 and thus is incorporated into the single cable 250 between the electrical socket 300 and the gateway device 200.

The CAN I/O interface 212 supports controller area network communications and allows the gateway device 200 to establish a controller area network (CAN)-based connection between one or more devices at the trailer 120 and the electrical system of the tractor 110. In some examples, the gateway device 200 includes a plurality of CAN input ports (e.g., CAN input terminals) 212a that allow the device 200 interface with various vehicle sensors including one or more tire pressure sensors 128 for measuring the air pressure of one of more trailer tires, one or more light check sensors 129 for checking the operational state and detecting failures of the trailer lights, etc. However, this is merely an example, and the gateway device 200 may interface with any suitable type of sensor including, but not limited to, a cargo sensor, a thermal camera, a wheel-end temperature sensor, an axle lube temperature sensor, an ultrasonic or radar back up sensor, a back up time-of-flight sensor, a kingpin height sensor, boogey position sensor, door sensor, door lock sensor, an ATIS pressure sensor, an ATIS status sensor, a yaw sensor, an accelerometer, a lane keeping sensor, a liftgate battery voltage/current sensor, a liftgate cycle counter, a brake pad wear sensor, a brake temperature sensor, a tire treadwear sensor, a blind spot monitoring sensor, a wheel speed sensor, a weight sensor, a floor load sensor.

The PLC I/O interface 213 facilitates power line carrier communication, which enables efficient data exchange over the existing power lines of the vehicle 100. For example, this interface and the corresponding power/PLC input port/terminal 213a allow the gateway device 200 to establish communication with, and act as an intermediary (e.g., a pass-through device) between, the tractor and trailer ABS modules 140a and 140b. In some examples, in addition to or in lieu of the PLC connection to the ABS modules 140a and 140b, the gateway device 200 may have a CAN-based or ethernet-based connection to the ABS modules 140a and 140b.

In some examples, the gateway device 200 may act as a protocol translator, translating incoming signals in one protocol to outgoing signals of a different protocol. For example, when a legacy trailer is using 11992 CAN for communication, but the tractor is using ethernet for braking communication, the gateway device 200 can translate the ethernet-based signal to a 11992-CAN based signal and visa-versa to prevent the new tractor from having to support both protocols.

Thus, the ethernet, CAN bus, and PLC interfaces 211-213 of the gateway device 200 together support communication with various vehicle systems and sensors, enhancing the overall connectivity of the tractor 110 and trailer 120.

The GPS device 214 integrated within the housing 202 provides the gateway device 200 with precise location tracking, which may enhance telematics and navigation functionalities of the vehicle 100. For example, the gateway device 200 may transmit the location data (e.g., real-time location data) collected by the GPS device 214 (via the CAN I/O interface 212) to a telematics device at the nosebox of the trailer 120 or at the tractor 110 for communication to a fleet management system, and thus contribute to improving operational efficiency and route planning. The position data produced by the GPS device 214 may also enable other functions based on geographic location. For example, the trailer position may be used to alert the driver of the need to adjust tandem position when crossing state lines, or may be used to alert the driver of an open door while driving. In some examples, the gateway device 200 includes a GPS input port (e.g., GPS input terminal) 214a for an external GPS antenna 234 to accommodate for times when telematics functionality requires a more accurate signal than what can be achieved with the integrated antenna of the GPS device 214.

The LODS 215 provides light-out detection capabilities for monitoring the trailer's lighting systems. In some examples, the LODS 215 communicates with one or more light sensors 129 at the trailer 120 through the CAN I/O interface 212 and relay the information (e.g., failure alerts) to the VSC 112 and/or the HMI 114 of the tractor via the cable 250 and electrical socket 300. This functionality may enhance safety by ensuring that any lighting failures are promptly detected and addressed.

The TPMS 216 communicates with one or more tire pressure monitoring sensors 128 at the trailer 120 and allows the gateway device 200 to provide the tractor 110 (e.g., the VSC 112 and/or the HMI 114) real-time monitoring and alerts for any deviations from optimal pressure levels. Thus, the TPMS 216 helps to ensure safety and operational efficiency.

The communication block (e.g., a communication circuit) 217 with a wireless transceiver that can communicate with the tire pressure monitoring sensors 128 using various wireless communication protocols (e.g., 433 MHz or the like). The gateway device 200 may also include a wireless/cellular input port (e.g., wireless/cellular input terminal) 217a for connecting an external antenna 237 for situations when the internal antenna of the communication block 217 is insufficient. Additionally, the communication block 217 may include an integrated Bluetooth or BLE transceiver 218 and may incorporate a bluetooth input port (e.g., bluetooth input terminal) for an external BLE antenna 238 for situations when the internal antenna is insufficient.

The battery 219 may support operations of the gateway device 200 when not connected to a towing vehicle 110. In some examples, the gateway device 200 may further include an auxiliary power input (e.g., an auxiliary power terminal) 219a for connecting to a solar panel input when a towing vehicle is not connected to not turned on. This auxiliary source of energy may be used to charge the battery 219

The processor 220 serves as the central processing unit of the gateway device 200 and manages data flow and executes control algorithms for the gateway's various communication systems. The processor 220 ensures that the gateway device 200 can handle complex data processing tasks and supports the advanced functionalities of the communication system. The memory 221 provides storage for data and system configurations that are required for system operation.

As used herein, the term “processing circuit” includes any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed wiring board (PWB) or distributed over several interconnected PWBs. A processing circuit may contain other processing circuits; for example, a processing circuit may include two processing circuits, an FPGA and a CPU, interconnected on a PWB.

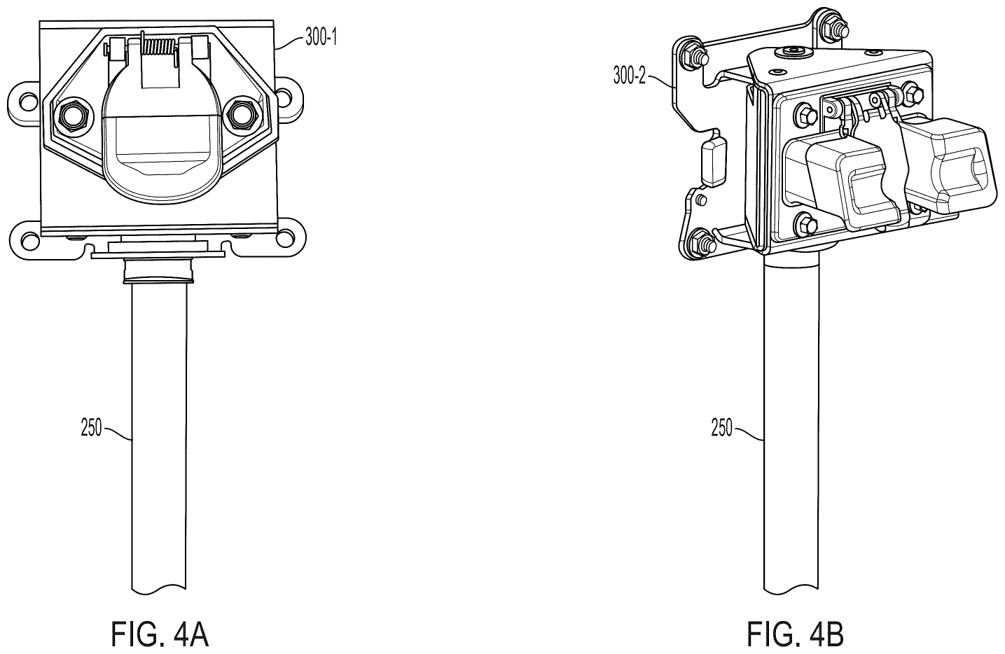

FIG. 4A illustrates the electrical socket 300 according to some embodiments of the present disclosure; and FIG. 4B illustrates the electrical socket 300-1 according to some other embodiments of the present disclosure.

According to some embodiments, the electrical socket coupled to the gateway device 200 may be provided in different forms to support a variety of connection types. For example, the electrical socket may be a 7-way SAE (society of automotive engineers) J560 socket (e.g., a J560 swivel or non-swivel socket) 300-1 as shown in FIG. 4A, or an EC47 socket (e.g., an EC47 swivel or non-swivel socket) 300-2 as shown in FIG. 4B. The J560 socket is a standard primary and auxiliary jumper cable receptacle for the truck-trailer. The EC47 socket is a tractor-trailer connector that allows for high-speed communication, power transfer, and safety between a tractor and trailer. The EC4 7socket may provide ethernet, CAN, and 4 auxiliary connections for future connectivity options that are cross-compatible with standard 7-way SAE J560 connections, without adapters.

The electrical socket 300 may be installed on the nose of the trailer 120 and may take up much less space than a nose box of the related art. The electrical socket 300 may serve as the primary means of connecting the tractor 110 to the trailer 120 and also may incorporate a means of connecting additional ancillary nose-mounted devices so additional wiring does not have to be routed through the kingpin plate to connect these devices to the smart vehicle connection box. The single cable connecting the electrical socket 300 to the gateway device 200 may be any one of the standard harness solutions that have been sized to allow for routing through existing kingpin plates 122 of any trailer manufacturer without the need for re-design of the kingpin plate 122.

Accordingly, as described above, the gateway device 200 and the communication system 150 utilizing the same presents a significant departure from nose boxes of the related art in the trailer connectivity domain.

For example, the gateway device 200 provides enhanced connectivity options including ethernet. Nose boxes of the related art primarily focus on basic electrical connections, ensuring power distribution and basic signal transmission. The gateway device 200, on the other hand, integrates ethernet connectivity. Ethernet allows for high-speed data transfer, enabling trailers to communicate in real-time with other systems, be it for fleet management, diagnostics, or other smart functionalities. This level of connectivity can enable advanced telematics integration, IoT functionalities, and more, making trailers an active participant in the digital ecosystem rather than just a passive entity. This is especially crucial in an era where timely data can lead to more informed decisions, whether it is related to fleet management, maintenance, or cargo handling.

Further, the gateway device 200 provides a compact yet versatile design, which is very desirable as space is at a premium on trailers. The nose boxes of the related art often come in standardized sizes, which might not always be optimal for every trailer type or configuration. The gateway device 200, with its compact design, ensures efficient use of space without compromising on functionality. Its design ensures that, despite its compactness it offers all the advanced connectivity options that are desirable in modern trailers. This versatility ensures that it is compatible with a wide range of trailers, from older models to the latest ones.

Furthermore, one of the significant challenges with introducing new technology to the transportation industry is the issue of retrofitting. The gateway device 200 addresses this challenge by having a design that ensures easy integration into existing trailers without the need for extensive modifications. This not only reduces the costs associated with adopting the new system but also ensures that even older trailers can benefit from the advanced connectivity options it offers.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art. Further, if the term “substantially” is used in combination with a feature that could be expressed using a numeric value, the term “substantially” denotes a range of +/−5% of the value centered on the value.

As used herein, the terms “use,” “using,” and “used” may be considered synonymous with the terms “utilize,” “utilizing,” and “utilized,” respectively.

When one or more embodiments may be implemented differently, a specific process order may be performed differently from the described order. For example, (i) the disclosed operations of a process are merely examples, and may involve various additional operations not explicitly covered, and (ii) the temporal order of the operations may be varied.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

While this invention has been described in detail with particular references to exemplary embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

What is claimed is:

1. A gateway device of a trailer, comprising:
a processing circuit configured to enable bi-directional communication between electrical devices at the trailer and an electrical system of the tractor; and
a housing encompassing the processing circuit and coupled to an underside of the trailer, the housing comprising a terminal configured to be electrically coupled to an electrical socket at a front side of the trailer via a single cable that passes through a kingpin plate at the underside of the trailer.

2. The gateway device of claim 1, wherein the housing is coupled between two adjacent cross-beams above a landing gear of the trailer.

3. The gateway device of claim 1, wherein the processing circuit is configured to directly communicate with at least one of a vehicle communication system (VCS) or a human-machine interface (HMI) at the tractor, without intervention of an anti-lock braking system (ABS) module of the tractor.

4. The gateway device of claim 1, wherein the processing circuit is configured to communicate with an anti-lock braking system (ABS) module of the tractor via at least one of a power line carrier (PLC) communication link, an ethernet link, or a controller area network (CAN)-based connection.

5. The gateway device of claim 1, wherein the processing circuit comprises an ethernet router configured to establish an ethernet-based connection between at least one of one or more cameras or one or more sensors at the trailer and the electrical system of the tractor.

6. The gateway device of claim 1, wherein the processing circuit is configured to enable communication between a first anti-lock braking system (ABS) module at the tractor and a second anti-lock braking system (ABS) module at the trailer via power line carrier (PLC), ethernet, or controller area network (CAN) communication links.

7. The gateway device of claim 1, wherein the processing circuit is configured to establish a controller area network (CAN)-based connection between one or more devices at the trailer and the electrical system of the tractor.

8. The gateway device of claim 7, wherein the one or more devices at the trailer comprise at least one of a tire pressure sensor or a light check sensor.

9. The gateway device of claim 1, wherein the single cable passes through an opening in the kingpin plate at the underside of the trailer, the opening having a diameter of about 1 inch to about 2 inches.

10. A communication system of a trailer, comprising:
a gateway device configured to enable bi-directional communication between electrical devices at the trailer and an electrical system of the tractor, and coupled to an underside of the trailer; and
an electrical socket at a front side of the trailer and configured to be coupled to an electrical system of a tractor via a harness, the electrical socket being communicatively coupled to the gateway device via a single cable that passes through a kingpin plate at the underside of the trailer.

11. The communication system of claim 10, wherein the gateway device is coupled between two adjacent cross-beams above a landing gear of the trailer.

12. The communication system of claim 10, wherein the gateway device is configured to directly communicate with at least one of a vehicle communication system (VCS) or a human-machine interface (HMI) at the tractor, without intervention of an anti-lock braking system (ABS) module of the tractor.

13. The communication system of claim 10, wherein the gateway device is configured to communicate with an anti-lock braking system (ABS) module of the tractor via at least one of power line carrier (PLC) communication links, an ethernet link, or a controller area network (CAN)-based connection.

14. The communication system of claim 10, wherein the gateway device comprises an ethernet router configured to establish an ethernet-based connection between one or more cameras at the trailer and the electrical system of the tractor.

15. The communication system of claim 10, wherein the gateway device is configured to enable communication between a first anti-lock braking system (ABS) module at the tractor and a second anti-lock braking system (ABS) module at the trailer via power line carrier (PLC) communication links.

16. The communication system of claim 10, wherein the gateway device is configured to establish a controller area network (CAN)-based connection between one or more devices at the trailer and the electrical system of the tractor.

17. The communication system of claim 16, wherein the one or more devices at the trailer comprise at least one of a tire pressure sensor or a light check sensor.

18. The communication system of claim 10, wherein the electrical socket comprises a SAE J560 socket, and
wherein the harness is a primary and auxiliary seven conductor electrical connector for truck-trailer jumper cable.

19. The communication system of claim 10, wherein the electrical socket comprises an EC47 socket comprising an ethernet terminal, a controller area network (CAN) terminal, and a J560 receptor, and
wherein the harness comprises conductors for carrying ethernet signals, CAN signals, and signals compatible with SAE J560.

20. The communication system of claim 10, wherein the single cable passes through an opening in the kingpin plate at the underside of the trailer, the opening having a diameter of about 1 inch to about 2 inches.
